(19) United States
(12) Patent Application Publication
(10) Pub. No.: US 2003/0222891 A1
(43) Pub. Date: Dec. 4, 2003

(54) Method, apparatus and system for synthesizing images, program for executing image synthesis and computer-readable medium including the program

(76) Inventor: Keisuke Okamoto, Osaka-fu (JP)

Correspondence Address: DICKSTEIN SHAPIRO MORIN & OSHINSKY LLP, 2101 L STREET NW, WASHINGTON, DC, 20037-1526, US

(21) Appl. No.: 10/445,844

(22) Filed: May 28, 2003

(30) Foreign Application Priority Data
May 31, 2002 (JP) P.2002-160625

(51) Int. Cl. G09G 5/397

(52) U.S. Cl. 345/646; 345/546

(57) ABSTRACT

A face image synthesis server includes a morphing section, a base image generation section, and a feature addition section. The morphing section synthesizes two or more images by morphing. The base image generation section acquires two or more face images and synthesizes the face images by the morphing section to generate a base image. The feature addition section acquires a feature face image and synthesizes the feature face image and the base image by the morphing section to generate a feature-added image. Accordingly, the face images can be synthesized to generate a real face image and a resultant image to which a feature not contained in the original images is added can be generated.

### BACKGROUND OF THE INVENTION

1. Field of the Invention

The present invention relates to a method and apparatus for synthesizing images and a system for synthesizing images. The present invention also relates to a program for executing an image synthesis and a computer-readable medium including the program.

2. Description of the Related Art

Japanese Utility Model Registration No. 3042477 (issuance date: Oct. 21, 1997) describes a game machine for synthesizing image data of a couple to generate an image of a baby of the couple and further editing the image in accordance with the growth of the child.

However, this game machine has the following drawbacks. First, since the image data are synthesized by montage, a natural and elaborate resultant image cannot be provided. In addition, an image after the child grows up cannot be automatically generated. Further, to play a game, the user needs to go to a location where the game machine is installed. Therefore, this game machine lacks in practicality as an entertainment machine.

### SUMMARY OF THE INVENTION

It is therefore an object of the present invention to provide a method and apparatus for synthesizing images and a system for synthesizing images, which can synthesize, for example, face images to generate a real face image and further add a feature not contained in the original face images. It is also an object of the present invention to provide a program for executing an image synthesis and-a computer-readable medium including the program.

In order to accomplish the objects above, the following section is adopted, using as an embodiment images such as face images. According to the present invention, there is provided a method of synthesizing images comprising:

acquiring a plurality of images, for example, two face images;

synthesizing the plurality of images, for example, two face images to generate a base image;

acquiring one or more feature images, for example, a feature face image; and

synthesizing the feature image and the base image to generate a feature-added image.

According to another aspect of the invention, there is provided an apparatus for synthesizing images comprising:

an image synthesis section for synthesizing images;

a base image generation section for acquiring a plurality of images, for example, two face images and synthesizing the plurality of images, for example, face images by the image synthesis section to generate a base image; and

a feature addition section for acquiring a feature image, such as a feature face image, and synthesizing the feature image and the base image by the image synthesis section to generate a feature-added image.

In the above-mentioned image synthesis method and apparatus, the two face images may be synthesized by morphing. The feature face image and the base image may be synthesized by morphing.

According to this method and this configuration, the two face images are synthesized, for example, by morphing and thus, a natural and elaborate image can be generated. In addition, the two original face images can be synthesized in any desired synthesis ratio. Therefore, delicate adjustments can be made to the extent desired.

Since the base image is synthesized with a feature face image, a feature not contained in the two original images can be added. For example, if average face images for each age are provided as feature face images, a face image of any desired age can be obtained based on an average face image of the age appropriately selected from among the average face images.

As such, a face image synthesis processing can be conducted in which a face image of a child forecasted from the face images of a couple is generated and a face image of any desired age from the birth to old age is generated. Therefore, the face image synthesis processing as described above, can realize an experience-oriented game, etc., improved in entertainment.

In the image synthesis method of the present invention, at least one of the base image generation step and feature-added image generation step may comprise automatically extracting feature points of the faces images to be synthesized.

In the image synthesis apparatus of the present invention, the image synthesis section may comprise a feature extraction section for automatically extracting feature points of the faces images to be synthesized.

According to this method and this configuration, the feature points used in morphing can be automatically extracted and thus the user does not need to point out and connect the feature points on the screen of a portable terminal. Therefore, the user can also use the face image synthesis processing comfortably from a machine such as a mobile phone limited in operation functions.

In the image synthesis method of the present invention, at least one of the base image generation step and feature-added image generation step may comprise setting a synthesis ratio of the images to be synthesized.

In the image synthesis apparatus of the present invention, the image synthesis section may set a synthesis ratio of the images to be synthesized.

The image synthesis section may set the synthesis ratio for each part of a face.

According to this method and this configuration, the synthesis ratio of synthesizing, for example, by morphing can be set for each face part, so that it is possible to generate diverse face images. The synthesis ratio can also be set collectively for the whole face.

The image synthesis apparatus of the present invention may further comprise a feature image database storing feature images such as feature face images, wherein the feature addition section acquires the feature image from the feature image database.

According to this configuration, for example, feature face images for each age, each gender, and each favorite face can be previously stored in the feature face image database. If the feature to be added to the base image is specified for the feature addition section before the base image and the feature face image are synthesized, the feature addition section acquires the feature face image responsive to the specified feature from the feature face image database and synthesizes the feature face image with the base image. Thus, the feature not contained in the original images can be added to the base image.

In the image synthesis method of the present invention, the face images acquiring step may acquire the face images from a portable terminal through a communication network, and the image synthesis method may further comprise transmitting the feature-added image to the portable terminal through the communication network. The image synthesis method may further comprise receiving a synthesis ratio of the two face images to be synthesized from the portable terminal through the communication network.

The image synthesis apparatus of the present invention may be connected to a portable terminal through a communication network, wherein the base image generation section acquires face images from the portable terminal and the feature addition section transmits the feature-added image to the portable terminal.

According to another aspect of the present invention, there is provided a system for synthesizing images comprising a portable terminal, and an image synthesis apparatus comprising an image synthesis section for synthesizing a plurality of images; a base image generation section for acquiring the plurality of images, for example, two face images and synthesizing the face images by the image synthesis section to generate a base image; and a feature addition section for acquiring a feature image such as a feature face image and synthesizing the feature image and the base image by the image synthesis section to generate a feature-added image.

According to this image synthesis system, the face images transmitted from the portable terminal are synthesized in the image synthesis apparatus and the provided feature-added image can be displayed on the portable terminal. The image synthesis system can also be constructed on a network for a server (image synthesis apparatus) to execute processing involving a large operation amount, thus enabling the user to use the face image synthesis processing with a handy portable terminal regardless of the place or time.

Therefore, the image synthesis system makes it possible to provide an experience-oriented game, etc., improved in entertainment on a communication network by using real image face synthesis. That is, it is possible to provide content using real face images in the communication network (for example, a rearing game such as a child-rearing game).

Further, according to another aspect of the present invention, there is provided a computer-readable medium including a program executable on a computer for operating an apparatus for synthesizing images, the program comprising instructions having: a first function of acquiring a plurality of images, such as two face images; a second function of synthesizing the plurality of images, such as two face images to generate abase image; a third function of acquiring a feature image, such as a feature face image in this example; and a fourth function of synthesizing the feature image and the base image to generate a feature-added image.

According to another aspect of the present invention, there is provided a program executable on a computer for operating an apparatus for synthesizing images, the program comprising instructions having: a first function of acquiring a plurality of images, such as two face images; a second function of synthesizing the plurality of images, such as the two face images to generate a base image; a third function of acquiring a feature image, such as a feature face image; and a fourth function of synthesizing the feature image and the base image to generate a feature-added image.

### BRIEF DESCRIPTION OF THE DRAWINGS

FIG. 1 is a functional block diagram showing a schematic configuration of a face image synthesis system according to an embodiment of the present invention;

FIG. 2 is a flowchart showing an outline of face image synthesis processing in the face image synthesis system according to the embodiment of the present invention;

FIG. 3 is a schematic drawing showing screen examples displayed on a portable terminal in a child-rearing game incorporating the face image synthesis system according to the embodiment of the present invention;

FIG. 4 is a schematic drawing showing screen examples displayed on the portable terminal in the child-rearing game incorporating the face image synthesis system according to the embodiment of the present invention;

FIG. 5 is a schematic drawing showing screen examples displayed on the portable terminal in the child-rearing game incorporating the face image synthesis system according to the embodiment of the present invention; and

FIG. 6 is a schematic drawing showing screen examples displayed on the portable terminal in the child-rearing game incorporating the face image synthesis system according to the embodiment of the present invention.

### DETAILED DESCRIPTION OF THE INVENTION

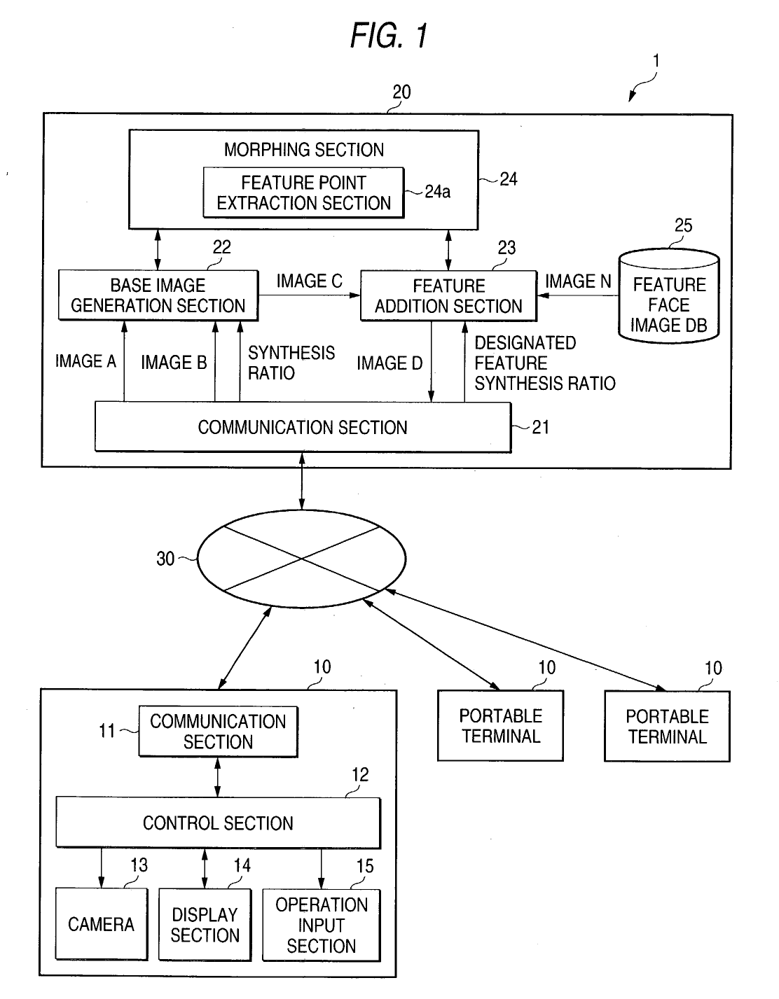

Referring now to the accompanying drawings (FIGS. 1 to 6), there is shown a preferred embodiment of the present invention.

An outline of a face image synthesis system (image synthesis system) 1 according to an embodiment of the present invention will be discussed with reference to FIG. 1.

The face image synthesis system 1 includes portable terminals 10, a face image synthesis server (image synthesis apparatus) 20, and a communication network 30. The portable terminals 10 and the face image synthesis server 20 are connected through the communication network 30 so that they can communicate with each other. The communication network 30 includes base stations and central exchange offices of a telecommunications carrier, servers of an Internet connection provider, etc. The face image synthesis system 1 has a function of synthesizing face images of two users photographed by the portable terminal 10 by the face image synthesis server 20 and displaying the resultant synthesized face image on the portable terminal 10.

The portable terminal 10 is an information communication machine such as a mobile phone that can communicate with the face image synthesis server 20 through the communication network 30. In the embodiment, the portable terminal 10 is described as a mobile phone.

The portable terminal 10 includes at least a communication section 11, a control section 12, a camera 13, a display section 14, and an operation input section 15.

The communication section 11 is an interface with the communication network 30. The control section 12 controls the whole portable terminal 10. The camera 13 can photograph a face image of the user. The display section 14 is an LCD (liquid crystal display), etc., and the operation input section 15 is a touch panel, a button, a dial, etc. That is, the portable terminal 10 provides a user interface implemented as the display section 14 and the operation input section 15.

The portable terminal 10 has a function of photographing a face image of the user by the camera 13, transmitting the face image to the face image synthesis server 20, receiving a feature-added image D generated by the face image synthesis server 20, and displaying the feature-added image D on the display section 14. Thus, the control section 12 provides a function as a client for accessing the face image synthesis server 20 and using a service provided by the face image synthesis server 20 through the portable terminal 10.

In the embodiment, the case where face images of a couple are photographed by the portable terminal 10 and are synthesized by the face image synthesis server 20 will be discussed. However, the number of face images synthesized by the face image synthesis server 20 may be three or more. The number of portable terminals 10 connected to the face image synthesis server 20 may be one or may be two or more. Specifically, user face images A and B may be transmitted from one portable terminal 10 or may be transmitted from two different portable terminals 10 and 10. If the face image synthesis server 20 receives images A and B from two portable terminals 10 and 10, it transmits a feature-added image D to either or both the portable terminals 10 and 10 according to the user selection.

The face image synthesis server 20 includes at least a communication section 21, a base image generation section 22, a feature addition section 23, a morphing section 24, and a feature face image database 25 (hereinafter referred to as a feature face image DB 25).

The communication section 21 is an interface with the communication network 30.

The base image generation section 22 acquires two face images A and B from the portable terminal 10, synthesizes the face images A and B by the morphing section 24 to generate a base image C, and inputs the base image C to the feature addition section 23. In this embodiment, the face images A and B are synthesized by morphing.

The feature addition section 23 acquires a feature face image N from the feature face image DB 25 and synthesizes the feature face image N and the base image C to generate a feature-added image D. Then, the feature addition section 23 transmits the feature-added image D through the communication section 21 to the portable terminal 10 from which the face images A and B were received. The feature face image N is described later.

The morphing section 24 has a function of synthesizing two face images by morphing in response to requests sent from the base image generation section 22 and the feature addition section 23. The morphing section 24 includes a feature point extraction section 24a for automatically extracting feature points of the face images to be synthesized. The morphing section 24 also makes it possible to set the synthesis ratio of the two face images to be synthesized for each face part.

In general morphing, an operator manually points out feature points, and further connects the feature points for specifying a contour to establish correspondences between the two images. However, this work is hard to perform with a narrow screen and button operation of the portable terminal 10. Then, in the face image synthesis system 1, before two face images are synthesized by morphing, the feature point extraction section 24a automatically extracts the feature points of each face image. After this, the morphing section 24 brings the feature points of one face image into correspondence with those of the other, and performs morphing.

Specifically, the feature point extraction section 24a automatically extracts the feature points of each face (points on contours of eyes, eyebrows, nose, mouth, face, etc.,) from two face images A and B. The feature point extraction section 24a calculates a score of the extraction result (certainty factor) and compares the score with a preset threshold value. If the score is equal to or less than the threshold value, the extraction is determined a failure and the morphing is stopped. For example, if the image quality is poor or the face is cut or is not photographed, the extraction is determined a failure. Further, if the automatic extraction of the feature points results in failure, the extraction failure is reported to the base image generation section 22 and the users are requested to retransmit face images and are prompted to again take photographs.

The synthesis ratio of synthesizing by morphing the face images in the morphing section 24 is set by user's specification from the portable terminal 10 or automatic specification of the morphing section 24. As a specific setting method, for example, the synthesis ratio may be set separately for each face part (contour of eyebrow, eye, nose, mouth, face) or may be set collectively for the whole face. The synthesis ratio of the two image faces can be specified continuously in the range of 0% to 100%.

Next, the feature face image N is an image which is synthesized by morphing with a base image C to add features to the base image C. For example, if average face images of each age are stored in the feature face image DB 25 as the feature face images N, the feature addition section 23 acquires the feature face image N corresponding to any desired age from the feature face image DB 25 and synthesizes by morphing the extracted feature face image N and the base image C. Therefore, face's features of the desired age can be added to the base image C.

In the face image synthesis server 20, various patterns of the feature face images N for each age and for each gender are provided and are previously stored in the feature face image DB 25. Specifically, feature face images N of a number of patterns like the faces of some celebrities can be provided in the feature face image DB 25, and the user is requested to select one of them or the feature addition section 23 selects one of them. Accordingly, this may prevent the user from becoming bored of gaming should the user play the game repeatedly.

As a preparation method of feature face images N, for example, first, voluminous faces images are collected and are classified according to the age, gender, face's features, photograph conditions, etc. Classification according to the “face's features” is made from the viewpoint of “round face,” “wide forehead,” “downward slanting eyes,” “being similar to some celebrity,” etc., for example. Classification according to the “photograph conditions” is made from the viewpoint of “background (blue back, indoor or outdoor),” “image quality,” “lighting environment (daytime or nighttime photograph, etc.,)” “subject (front side face, side face, full-length figure),” etc., for example. Classification according to the photograph conditions is made to make uniform the image quality when images are synthesized and averaged, so that the image quality of the synthesized face images obtained by synthesizing and average face images to be added to the synthesized face image is uniform. The face images are synthesized for each classification to prepare average face images (feature face images N).

The face image synthesis server 20 can synthesis by morphing the feature face image N which is previously prepared as described above and the base image C which is provided by synthesizing the user's face images A and B acquired from the portable terminal 10. Therefore, features not contained in the user's face image A or B are added to the base image C to generate the feature-added image D. For example, if the feature face image N is an average face image provided for each age, delicate change in positional relationship, contours, skin color, wrinkles, etc., of parts of the face responsive to the age can be easily added without impairing the natural properties of the face image.

The feature face image N and the base image C are synthesized by morphing continuously in a complement-possible manner, whereby the state of the feature-added image D can be adjusted. For example, which of the original features of the couple and age features importance is placed on can be specified. Also, to what extent his or her feature reflects on the image of the child can be adjusted. That is, if the synthesis ratio of the base image C is set high, the original features of the couple will appear on the feature-added image D, but the features of the age, etc., become hard to be reflected on the feature-added image D. In contrast, if the synthesis ratio of the feature face image N is set high, the features of the age, etc., will appear on the feature-added image D, but the original features of the couple become hard to be reflected on the feature-added image D.

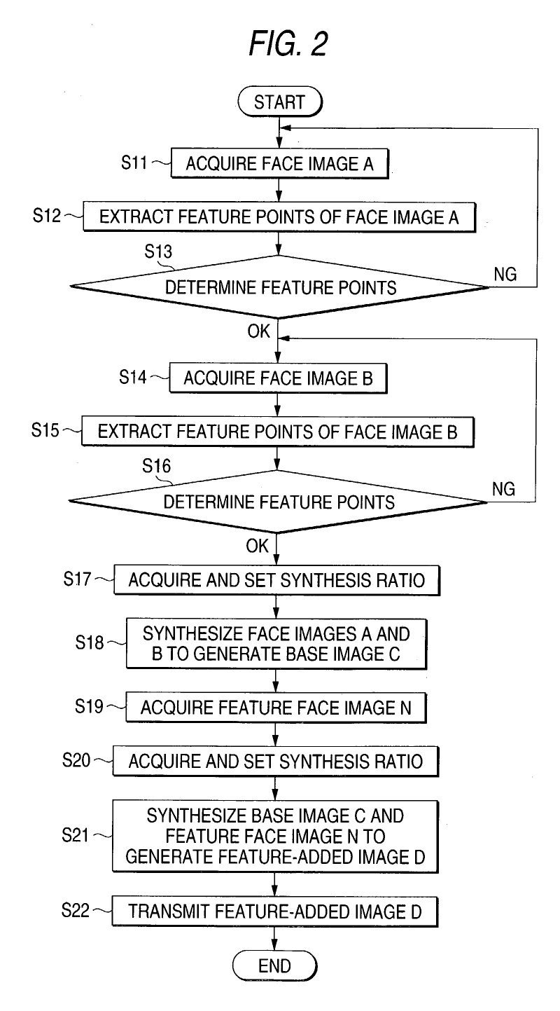

Next, the operation of the face image synthesis system 1 will be discussed mainly on processing of the face image synthesis server 20 with reference to FIG. 2.

The portable terminal 10 transmits a user's face image A to the face image synthesis server 20 (S11). The face image A may be photographed by the camera 13 or may be an image stored in memory (not shown) of the portable terminal 10.

Next, the face image synthesis server 20 inputs the received face image A to the morphing section 24 from the base image generation section 22 and automatically extracts feature points from the face image A for the morphing by the feature point extraction section 24a (S12). At this time, if the feature point extraction section 24a results in a failure in extracting the feature points (NG at S13), the base image generation section 22 requests the portable terminal 10 to again photograph and transmit a face image.

Next, if the face image synthesis server 20 succeeds in acquiring the face image A and extracting the feature points, it acquires a face image B and extracts feature points from the face image B like the face image A (S14 to S16).

Subsequently, the portable terminal 10 transmits the synthesis ratio of the face images A and B set by the user to the face image synthesis server 20. The base image generation section 22 sets the synthesis ratio received from the portable terminal 10 in the morphing section 24 (S17). The synthesis ratio may be set for each face part or may be set collectively for the whole face.

Next, the morphing section 24 synthesizes by morphing the face images A and B in response to the synthesis ratio to generate a base image C (step S18). The base image generation section 22 inputs the generated base image C to the feature addition section 23.

Next, the feature addition section 23 acquires a feature face image N from the feature face image DB25 (S19). The feature face image N to be acquired can be specified from the portable terminal 10.

Subsequently, the portable terminal 10 transmits the synthesis ratio of the base image C and the feature face image N set by the user to the face image synthesis server 20. The feature addition section 23 sets the synthesis ratio received from the portable terminal 10 in the morphing section 24 (S20). The synthesis ratio may be set for each face part or may be set collectively for the whole face.

Next, the morphing section 24 synthesizes by morphing the base image C and the feature face image N in response to the synthesis ratio to generate a feature-added image D (step S21). At step S19, a plurality of different feature face images N can also be acquired and synthesized with the base image C. The feature points of each feature face image N are previously extracted and are stored in the feature face image DB 25 in association with the image data of the feature face image N. As the feature points of the base image C, the feature points when the face images A and B are synthesized by morphing at step S18 are used. Of course, the feature points of the base image C and the feature face image N are extracted before step S21.

Then, the feature addition section 23 transmits the feature-added image D to the portable terminal 10 from which the face images A and B were received (acquired) at steps S11 and S14 (S22). That is, if the two face images A and B are received (acquired) from one portable terminal 10, the feature addition section 23 transmits the feature-added image D to the one portable terminal 10. If the two face images A and B are received (acquired) from two portable terminals 10 and 10, the feature addition section 23 transmits the feature-added image D to the two portable terminals 10 and 10.

As described above, the face image synthesis system 1 can synthesize the face images of the users and also add the features not contained in the original face images to the synthesized face image naturally and elaborately. Delicate adjustments as to the extent to which part is made similar to which man and woman can be made. Therefore, it is possible to realize an experience-oriented game, etc., improved in entertainment by using the real face image synthesis. In addition, the face image synthesis system 1 can be constructed on a network for the server to execute processing involving a large operation amount, thus enabling the user to play a game using a handy portable terminal regardless of the place or time.

Next, a child-rearing game of network content will be discussed as an application example of the described image synthesis method.

For the child-rearing game, the face image synthesis server 20 performs processing other than the face image synthesis. That is, the face image synthesis server 20 becomes a network game server. The face image synthesis server 20 has a function of storing child data prepared by the user, synthesizing face images to get a face image responsive to the age at the point in time at which the user accesses the face image synthesis server 20, and transmitting the resultant face image to the portable terminal 10. The face image synthesis server 20 brings up the child as the user accesses the face image synthesis server 20 or regardless of user access.

Two people may share one portable terminal 10 or each may use one portable terminal 10. That is, images A and B may be transmitted from different portable terminals 10 to the face image synthesis server 20. If the images A and B are transmitted from two portable terminals 10, the face image synthesis server 20 transmits a feature-added image D to both the portable terminals 10.

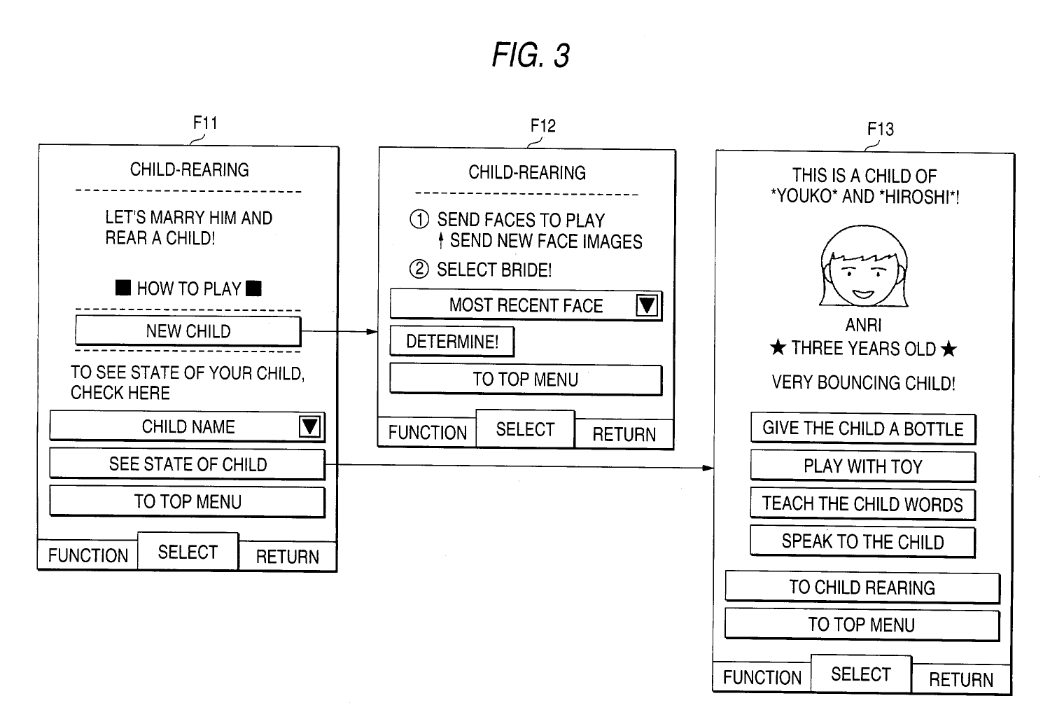

FIGS. 3 to 6 provide screen examples displayed on the portable terminal 10 in the child-rearing game. The game contents and screen examples described below are for illustrative purposes only and the invention is not limited to these examples.

When the user starts the child-rearing game in the portable terminal 10, a screen F11 (FIG. 3) is displayed. On the screen F11, a selection menu includes items NEW CHILD and STATE OF CHILD. To start a new game, the user selects NEW CHILD and goes to a screen F12 (FIG. 3). To continue a previous child-rearing game, the user selects the name of the child out of a pull-down menu of CHILD NAME and then selects SEE STATE OF CHILD and goes to a screen F13 (FIG. 3).

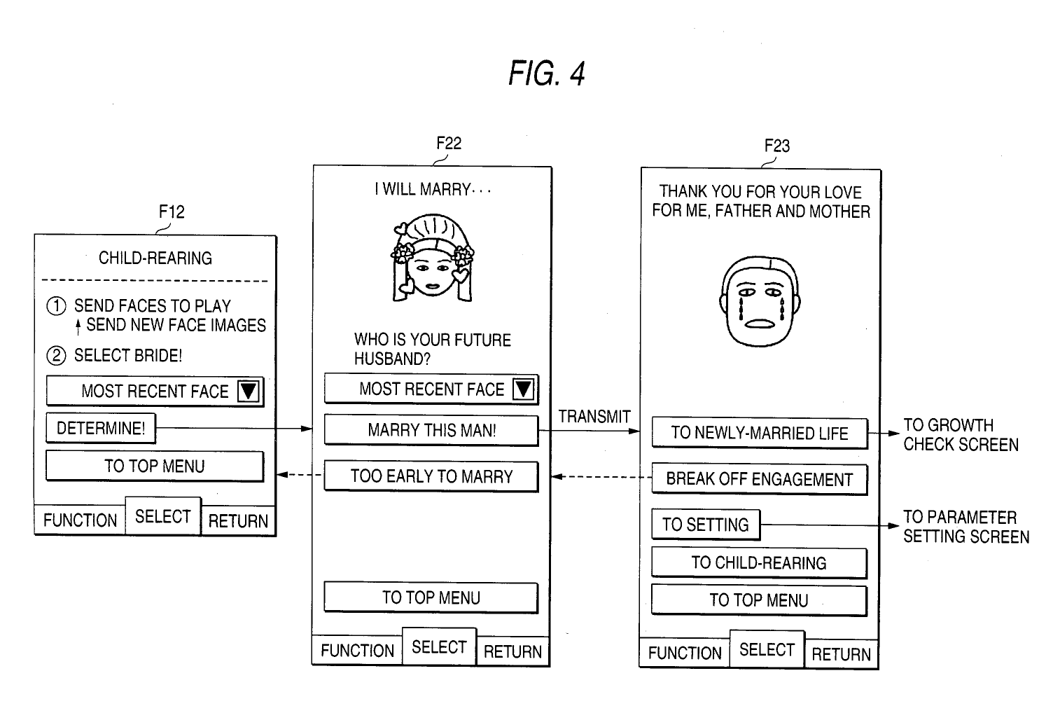

On the screen F12 (FIG. 4), the user selects a face image of a female out of a pull-down menu of SELECT BRIDE and selects DETERMINE, whereby the face image of the female is transmitted to the face image synthesis server 20. If the user selects TO CHILD-REARING on each operation screen, the screen returns to the game start screen F11. If the user selects TO TOP MENU, the screen returns to a menu screen of the portable terminal 10 (not shown).

Next, on a screen F22 (FIG. 4), the user selects a face image of a male out of a pull-down menu of WHO IS YOUR FUTURE HUSBAND? and selects MARRY THIS MAN, whereby the face image of the male is transmitted to the face image synthesis server 20. If the user selects TOO EARLY TO MARRY, the screen returns to the screen F12. If the user selects MARRY THIS MAN on the screen F22, the user goes to a screen F23 (FIG. 4).

On the screens F12 and F22, a face image used for the game is selected from among the already photographed face images and is transmitted to the face image synthesis server 20. Therefore, if a proper face image is not stored in the portable terminal 10, an operation screen for photographing a face image (not shown) is displayed.

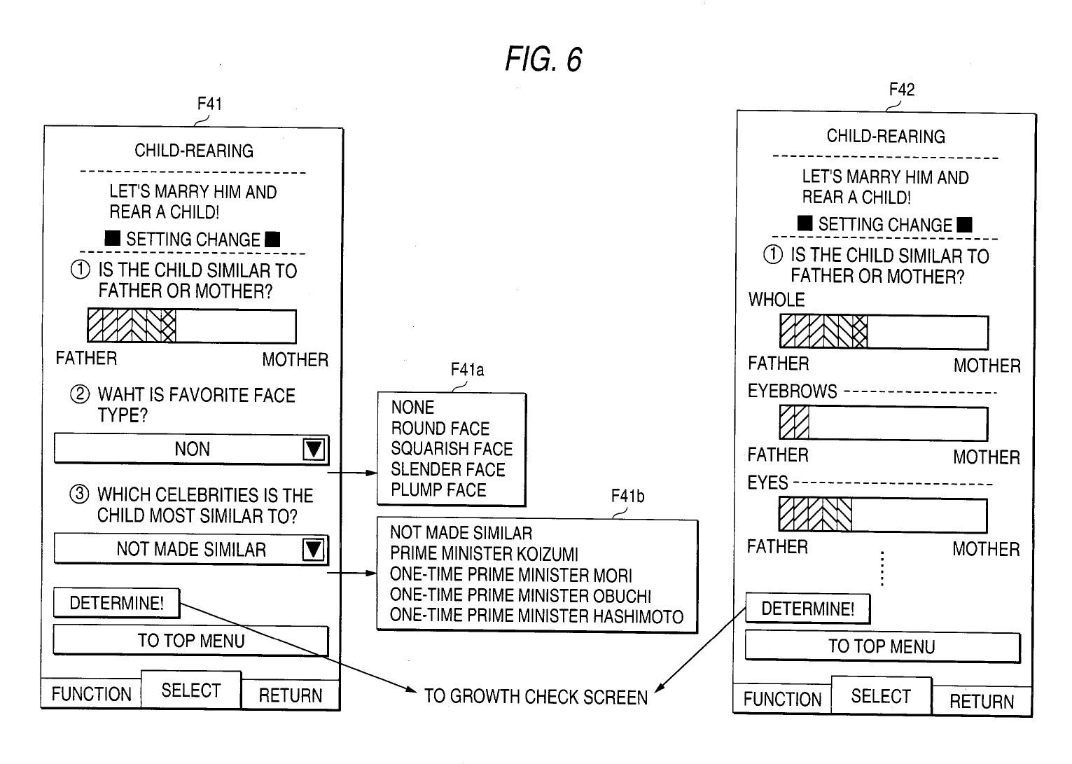

Next, if the user selects TO NEWLY-MARRIED LIFE on the screen F23, a growth check screen is displayed. If the user goes to the growth check screen from the screen F23, a face image to which features like a newborn baby are added is displayed. If the user selects BREAK OFF ENGAGEMENT, the screen returns to the screen F22. If the user selects TO SETTING, the user goes to a child image generation parameter setting screen (screen F41, F42 in FIG. 6).

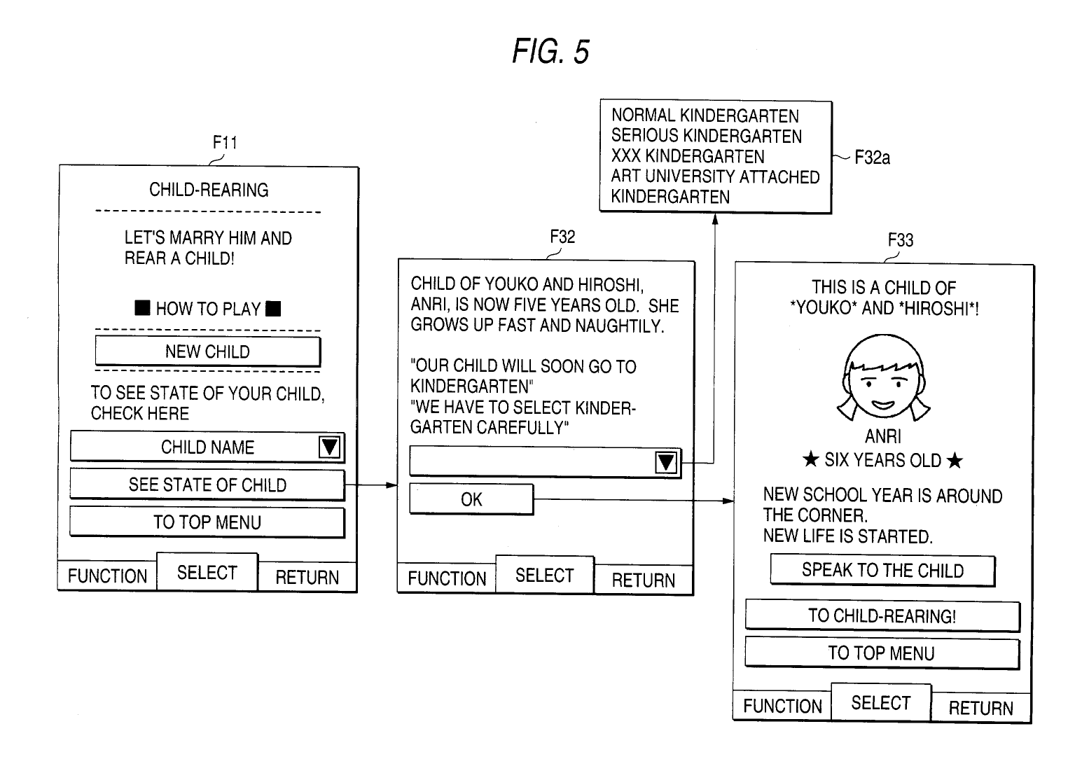

If the user selects a name of a child out of a pull-down menu of CHILD NAME on the screen F11 (FIG. 5) and then selects SEE STATE OF CHILD, a screen F32 (FIG. 5) is displayed. The screen F32 (FIG. 5) is a screen displayed when the child is five years old. The user selects and displays a list F32a out of a pull-down menu and selects a kindergarten. Thus, a child-rearing story is preset in the face image synthesis server 20 so as to generate an event responsive to the age of the child.

A face image to which the features responsive to the age of the child are added (feature-added image D) is displayed on a screen F33 of a growth check screen by the above-described image synthesis method (base image generation section 22, feature addition section 23, morphing section 24, and feature face image DB 25). Description responsive to the age of the child is displayed on the growth check screen.

The growth check screen (screen F13, F33) displays commands for bearing the child, such as GIVE THE CHILD A BOTTLE, PLAY WITH TOY, TEACH THE CHILD WORDS, and SPEAK TO THE CHILD. The personality parameters of the child change in response to the command selected by the user. The personality parameters are reflected on the growth of the child and generated events.

Subsequently, the parameter setting screens will be discussed. On the screen F41 (FIG. 6), the user can answer questions such as: IS CHILD SIMILAR TO FATHER OR MOTHER?, WHAT IS FAVORITE FACE TYPE?, and WHICH CELEBRITIES IS THE CHILD MOST SIMILAR TO? If the user selects DETERMINE, the parameter setting screen changes to the growth check screen (F13, F33).

First, the user responds to IS CHILD SIMILAR TO FATHER OR MOTHER? with the synthesis ratio for synthesizing by morphing the face images of the male and the female. The default value of the synthesis ratio is 50%; if the ratio of the male is larger, the child is made similar to the father or if the ratio of the female is larger, the child is made similar to the mother. Further, the synthesis ratio can be set for each face part as shown on the screen F42 (FIG. 6). The synthesis ratio set on the screen F41 or F42 is transmitted to the face image synthesis server 20, and is set in the morphing section 24 by the base image generation section 22 as the synthesis ratio applied for generating a base image C from the male and female face images A and B.

Second, the user can respond to WHAT IS FAVORITE FACE TYPE? with facial features (ROUND FACE, SQUARISH FACE, SLENDER FACE, PLUMP FACE, etc., as features of the whole face, INWARD-SLANTING EYES, DOWNWARD-SLANTING EYES, NORMAL EYES, BRIGHT, CLEAR EYES, SLIT EYES, etc., as feature of eyes, for example,) selected out of a pull-down menu list F41a. The feature information is transmitted to the face image synthesis server 20, and is used for the feature addition section 23 to acquire a feature face image N from the feature face image DB 25. For this purpose, feature face images N corresponding to the feature information (facial features) are previously stored in the feature face image DB 25.

Third, the user can respond to WHICH CELEBRITIES IS THE CHILD MOST SIMILAR TO? with a name of a celebrity (PRIME MINISTER KOIZUMI, ONE-TIME PRIME MINISTER MORI, ONE-TIME PRIME MINISTER OBUCHI, ONE-TIME PRIME MINISTER HASHIMOTO, etc.,) selected out of a pull-down menu list F41b. The feature information (name of celebrity) is transmitted to the face image synthesis server 20, and is used for the feature addition section 23 to acquire a feature face image N from the feature face image DB 25. For this purpose, feature face images N corresponding to the feature information (names of celebrities) are previously stored in the feature face image DB 25.

Thus, the face image of the child displayed on the growth check screen is generated by synthesizing by morphing the face image for adding the feature of the age, the face image for adding the feature of FAVORITE FACE, and the face image for adding the feature of CELEBRITY as feature face images N with the base image C generated by synthesizing by morphing the face images A and B provided by photographing the users of the portable terminal 10. The synthesis ratio of each feature face image N to the base image C may be automatically set by the face image synthesis server 20 or may be able to be set from the portable terminal 10 like the synthesis ratio of the face images A and B to generate the base image C.

As described above, the face image synthesis system 1 makes it possible to provide content using real face images in the communication network (for example, a rearing game such as the child-rearing game). That is, using the face image synthesis server 20 as a content distribution server, distribution service of content high in entertainment can be provided for a telecommunications carrier such as a mobile phone company aiming at improving the ability to pull in more customers.

The portable terminal 10 is a mobile phone, etc., and can be implemented based on a general-purpose computer. For example, the portable terminal 10 can have an Internet viewing function (web browser software) and can be connected to the face image synthesis server 20 of a web server through the communication network 30. Specifically, a personal computer, a PDA (personal digital assistant), an Internet compatible TV, a videogame machine, a set top box, an Internet service connection compatible mobile phone, or the like can be used as the portable terminal 10. The face image synthesis server 20 can be implemented based on a general-purpose computer such as a workstation or a personal computer.

That is, each of the portable terminal 10 and the face image synthesis server 20 is made up of a CPU (central processing unit) for executing program instructions for providing the functions, ROM (read-only memory) storing boot logic, RAM (random access memory) for expanding the program, a storage unit (record medium) such as a hard disk for storing the program and various databases, input units of a keyboard, a mouse, a camera, etc., output units of a monitor, a loudspeaker, etc., and a network connection machine for connecting to an external network, which are connected by an internal bus.

The object of the present invention can also be accomplished as a computer-readable record medium recording the program code of the face image synthesis program of software for providing the described functions (executable program, intermediate code program, source program) that is supplied to a system or an apparatus and a computer (or CPU, MPU, or DSP) of the system or the apparatus reads and executes the program code recorded on the record medium. In this case, the program code read from the record medium provides the described functions and the record medium recording the program code forms the invention.

Specifically, the control section 12 of the portable terminal 10 and the base image generation section 22, the feature addition section 23, and the morphing section 24 of the face image synthesis server 20 are implemented as microprocessors, etc., and are operable to execute predetermined programs stored in memory (not shown) of the apparatus.

The record medium for supplying the program code can be detached from the system or the apparatus. The record medium may be a fixedly support medium so that the program code can be supplied. The record medium may be installed in the system or the apparatus so that the computer can directly read the recorded program code or may be installed as an external storage unit so that the recorded program code can be read through a program reader connected to the system or the apparatus.

For example, tape of magnetic tape, cassette tape, etc., a disk such as a magnetic disk of floppy disk, hard disk, etc., or an optical disk of a CD-ROM, MO, MD, DVD, CD-R, etc., a card of an IC card (memory card), an optical card, etc., or semiconductor memory of mask ROM, EPROM, EEPROM, flash ROM, etc., can be used as the record medium.

The program code may be recorded so that the computer can read the program code from the record medium for direct execution or may be recorded so that the program code is transferred from the record medium to a program storage area of main memory and then the computer can read the program code from the main memory for execution.

Further, it may be made possible for the system or the apparatus to connect to a communication network (including the Internet, intranet, etc.,) so that the program code is supplied through the communication network.

It is assumed that a program for reading the program code from the record medium and storing the program code in the main memory and a program for downloading the program code from the communication network are previously stored in the system or the apparatus so that the programs can be executed by the computer.

The described functions are provided not only as the computer executes the read program code, but also as the operating system, etc., operating on the computer performs part or all of the actual processing as instructed by the program code.

Further, the described functions are also provided as the program code read from the record medium is written into memory installed in a function expansion board placed in the computer or a function expansion unit connected to the computer and then the CPU, etc., installed in the function expansion board or the function expansion unit performs part or all of the actual processing as instructed by the program code.

As described above, the image synthesis method of the present invention includes acquiring two face images; synthesizing the two face images to generate a base image; acquiring a feature face image; and synthesizing the feature face image and the base image to generate a feature-added image.

The image synthesis apparatus of the present invention includes an image synthesis section for synthesizing two images; a base image generation section for acquiring two face images and synthesizing the face images by the image synthesis section to generate a base image; and a feature addition section for acquiring a feature face image and synthesizing the feature face image and the base image by the image synthesis section to generate a feature-added image.

For example, the two face images are synthesized by morphing, and the feature face image and the base image are synthesized by morphing.

Since the two face images are synthesized, for example, by morphing, a natural and elaborate image can be generated. Since the base image is synthesized with a feature face image, a feature not contained in the two original images can be added.

Thus, a face image synthesis processing can be conducted in which a face image of a child forecasted from the face images of a couple is generated and a face image of any desired age from the birth to old age is generated. Therefore, the image synthesis method or apparatus provides the advantage that using the face image synthesis processing as described above, it is possible to realize an experience-oriented game, etc., improved in entertainment.

In the image synthesis method of the present invention, at least one of the base image generation step and feature-added image generation step comprises automatically extracting feature points of the faces images to be synthesized.

In the image synthesis apparatus of the present invention, the image synthesis section comprises a feature extraction section for automatically extracting feature points of the faces images to be synthesized.

Therefore, the image synthesis method or apparatus provides the advantage that the user can also use the face image synthesis processing comfortably from a machine such as a mobile phone limited in operation functions.

In the image synthesis method of the present invention, at least one of the base image generation step and feature-added image generation step comprises setting a synthesis ratio of the images to be synthesized.

In the image synthesis apparatus of the present invention, the image synthesis section is set to a synthesis ratio of the images to be synthesized.

For example, the image synthesis section is set to a synthesis ratio for each part of a face.

Therefore, the image synthesis method or apparatus provides the advantage that the synthesis ratio of synthesizing, for example, by morphing can be set for each face part, so that it is possible to generate diverse face images.

The image synthesis apparatus of the present invention further comprises a feature face image database storing feature face images, wherein the feature addition section acquires the feature face image from the feature face image database.

The image synthesis apparatus provides the advantage that the feature addition section acquires the feature face image responsive to the specified feature from the feature face image database and synthesizes the feature face image with the base image. Therefore, a feature not contained in the original images can be added to the base image.

In the image synthesis method of the present invention, the face images acquiring step acquires the face images from a portable terminal through a communication network, and the image synthesis method further comprises transmitting the feature-added image to the portable terminal through the communication network. The image synthesis method may further comprise receiving a synthesis ratio of the tow face images to be synthesized from the portable terminal through the communication network.

The image synthesis apparatus of the present invention further may be connected to a portable terminal through a communication network, wherein the base image generation section acquires face images from the portable terminal and the feature addition section transmits the feature-added image to the portable terminal.

The image synthesis system of the invention includes the above-described image synthesis apparatus and the above-described portable terminal.

According to this image synthesis system, it is possible to provide an experience-oriented game, etc., improved in entertainment on a communication network by using real image face synthesis. That is, it is possible to provide content using real face images in the communication network (for example, a rearing game such as a child-rearing game).

The program executable on a computer for operating an apparatus for synthesizing images, comprises instructions having: a first function of acquiring two face images; a second function of synthesizing the two face images to generate a base image; a third function of acquiring a feature face image; and a fourth function of synthesizing the feature face image and the base image to generate a feature-added image.

The computer-readable medium according to the present invention includes the program.

Of course, the invention may be embodied in other forms or carried out in other ways without departing from the spirit thereof. For example, while the embodiments disclosed represent images of a persons face, other images, such as animals or art that is conducive to be synthesized could also be used. The present embodiments are therefore to be considered in all respects illustrative and not limiting, the scope of the invention being indicated by the appended claims, and all modifications falling within the meaning and range of equivalency are intended to be embraced therein.

What is claimed is:

1. A method for synthesizing images, the method comprising:
acquiring a plurality of images;
synthesizing the plurality of images to generate a base image;
acquiring one or more feature images; and
synthesizing the one or more feature images and the base image to generate a feature-added image.

2. The method for synthesizing images as claimed in claim 1, wherein the plurality of images are two face images and the one or more feature images are a feature face image, the two face images and the feature face image collectively known as faces images.

3. The method for synthesizing images as claimed in claim 2, wherein the two face images are synthesized by morphing.

4. The method for synthesizing images as claimed in claim 2, wherein the feature face image and the base image are synthesized by morphing.

5. The method for synthesizing images as claimed in claim 2, wherein at least one of the base image generation step and feature-added image generation step comprises automatically extracting feature points of the faces images to be synthesized.

6. The method of synthesizing images as claimed in claim 2, wherein at least one of the base image generation step and feature-added image generation step comprises setting a synthesis ratio of the faces images to be synthesized.

7. The method for synthesizing images as claimed in claim 2, wherein the face images acquiring step acquires the two face images from a portable terminal through a communication network, and wherein said image synthesis method further comprises:
transmitting the feature-added face image to the portable terminal through the communication network.

8. The method for synthesizing images as claimed in claim 2, wherein the face images acquiring step acquires the two face images from a portable terminal through a communication network, and wherein said image synthesizing method further comprises:
receiving a synthesis ratio of the faces images to be synthesized from the portable terminal through the communication network.

9. An apparatus for synthesizing images comprising:
an image synthesis section for synthesizing images;
a base image generation section for acquiring a plurality of images and synthesizing the plurality of images by said image synthesis section to generate a base image; and
a feature addition section for acquiring one or more feature images and synthesizing the one or more feature images and the base image by said image synthesis section to generate a feature-added image.

10. The apparatus for synthesizing images as claimed in claim 9, wherein the plurality of images are two face images and the one or more feature images are a feature face image, the two face images and the feature face image collectively known as faces images.

11. The apparatus for synthesizing images as claimed in claim 10, wherein the image synthesis section synthesizes the images by morphing.

12. The apparatus for synthesizing images as claimed in claim 10, wherein said image synthesis section comprises a feature extraction section for automatically extracting feature points of the faces images to be synthesized.

13. The apparatus for synthesizing images as claimed in claim 10, wherein said image synthesis section sets a synthesis ratio of the faces images to be synthesized.

14. The apparatus for synthesizing images as claimed in claim 9, further comprising:
a feature image data base for storing the one or more feature images,
wherein said feature addition section acquires the feature image from the feature image database.

15. The apparatus for synthesizing images as claimed in claim 10, wherein said image synthesis apparatus is connected to a portable terminal through a communication network, wherein said base image generation section acquires the face images from the portable terminal and said feature addition section transmits the feature-added image to the portable terminal.

16. A system for synthesizing images comprising:
a portable terminal: and
an image synthesis apparatus comprising an image synthesis section for synthesizing images; a base image generation section for acquiring a plurality of images and synthesizing the plurality of images by said image synthesis section to generate a base image; a feature addition section for acquiring one or more feature images and synthesizing the one or more feature images and the base image by said image synthesis section to generate a feature-added image.

17. A computer-readable medium including a program executable on a computer for operating an apparatus for synthesizing images, said program comprising instructions having:
a first function of acquiring a plurality of images;
a second function of synthesizing the plurality of images to generate a base image;
a third function of acquiring one or more feature images; and
a fourth function of synthesizing the one or more feature images and the base image to generate a feature-added image.

18. A program executable on a computer for operating an apparatus for synthesizing images, said program comprising instructions having:
a first function of acquiring a plurality of images;
a second function of synthesizing the plurality of images to generate a base image;
a third function of acquiring one or more feature images; and
a fourth function of synthesizing the one or more feature images and the base image to generate a feature-added image.
